(19) United States
(12) Patent Application Publication
(10) Pub. No.: US 2009/0270075 A1
(43) Pub. Date: Oct. 29, 2009

(54) WORLDWIDE WIRELESS RATING SYSTEMS

(76) Inventor: GREGORY E. SMITH, (US)

Correspondence Address: GREGORY E SMITH, 207 NORTH THIRD STREET, BARDSTOWN, KY, 40004, US

(21) Appl. No.: 11/946,015

(22) Filed: Apr. 23, 2008

(51) Int. Cl. H04M 3/42

(52) U.S. Cl. 455/414.1

(57) ABSTRACT

Software that allows multiple wireless carrier services to be compared on a mobile network connected device, for voice and/or data, allowing that device to connect and utilize the selected wireless network of choice instantaneously. The software will allow an end user to determine which wireless carrier services to use based on such attributes of the network as quality of performance for a geographic area, network connectivity costs and available network services.

Software that allows multiple wireless carriers'services to be compared on a mobile network connected device for, voice and/or data, allowing that device to connect and utilize the selected wireless network of choice instantaneously. The software will allow an end user to determine which wireless carrier services to use based on such attributes of the network as quality of performance for a geographic area, network connectivity costs and available network services.

Options in the software also will automatically, based on the end user's preferences, transfer in real-time, the user's voice and/or data connection from one carrier to another due to a wireless carrier's failure to meet the minimum performance requirements setup by the end user. The end user will also be able to preset which wireless network to utilize based on the actual location of the mobile network connected device, date and time, and/or costs associated with the available wireless networks. The software, by default, will select the lowest network connectivity cost available based on the user's minimum preferences amongst the available wireless networks. The software will also offer the end user the option of manually choosing which network to utilize in real-time and override the default wireless connection.

The embodiments of the invention in which an exclusive property or privilege is claimed are defined as follows:

1. A software program comprising: a client application residing on a mobile network connected device that allows that mobile device to utilize any wireless carriers'services of choice instantaneously for voice and/or data.

2. The software program recited in claim 1 wherein that software allows the mobile network connected device to determine which wireless carriers'services to use based on such attributes of the network as quality of performance for a geographic area, network connectivity costs and available network carriers'services.

3. The software program recited in claim 1 wherein that software allows an end user to have preferred options to be configured in the software that will automatically transfer in real time, the mobile network connected device, voice and/or data connection, from one wireless network carrier to another due to a wireless carrier's failure to meet the minimum performance requirements setup by the end user.

4. The software program recited in claim 1 wherein that software allows the mobile network connected device to allow the end user of the mobile network connected device to be able to preset which wireless networks to utilize based on the actual geographic location of the mobile network device, data and time, and/or costs associated with the available wireless networks in that geographical area.

5. The software program recited in claim 1 wherein that software allows the mobile network connected device, by default, will select the lowest network connectivity cost based on the user's minimum preferences amongst the available wireless networks.

6. The software program recited in claim 1 wherein that software allows the mobile network connected device to offer the end user the option of manually choosing which network to utilize in real-time and override the software's default wireless connection settings.
